(19) United States
(12) Patent Application Publication
(10) Pub. No.: US 2024/0023598 A1
(43) Pub. Date: Jan. 25, 2024

(54) AEROSOL-GENERATING ARTICLE COMPRISING DUAL AEROSOL GENERATING-SUBSTRATES

(71) Applicant: Philip Morris Products S.A., Neuchatel (CH)

(72) Inventors: Rui Nuno Rodrigues Alves BATISTA, Morges (CH); Bekele Alemu BEDASSO, Neuchatel (CH); Gianluca BONGIOVANNI, Colombier (CH); Valerio OLIANA, Pully (CH); Alexandra SEREDA, Zurich (CH)

(73) Assignee: Philip Morris Products S.A., Neuchatel (CH)

(21) Appl. No.: 18/256,164

(22) PCT Filed: Dec. 16, 2021
(86) PCT No.: PCT/EP2021/086300

§ 371 Date: Jun. 6, 2023

(30) Foreign Application Priority Data
Dec. 17, 2020 (EP) 20215085.0
Dec. 17, 2020 (EP) 20215100.7
Dec. 17, 2020 (EP) 20215112.2
Feb. 2, 2021 (EP) 21154876.3

(51) Int. Cl. A24D 1/20; A24F 40/20; A24F 40/465

(52) U.S. Cl. CPC A24D 1/20; A24F 40/20; A24F 40/465

(57) ABSTRACT

An aerosol-generating article for generating an inhalable aerosol upon heating is provided, the article having proximal and distal ends and including: a first aerosol-generating substrate located between the distal end and the proximal end of the article; a first air inlet configured to admit air into the article; a second aerosol-generating substrate located between the first aerosol-generating substrate and the proximal end of the article; a second air inlet configured to admit air into the article; a first airflow pathway extending from the first air inlet through the first aerosol-generating substrate towards the proximal end of the article; and a second airflow pathway extending from the second air inlet through the second aerosol-generating substrate towards the proximal end of the article, the first airflow pathway and the second airflow pathway being isolated from one another. An aerosol-generating system including the article and an aerosol-generating device is also provided.

The present invention relates to an aerosol-generating article comprising dual aerosol-generating substrates for generating an inhalable aerosol upon heating. The present invention also relates an aerosol-generating system comprising the aerosol-generating article and an electrically-operated aerosol-generating device configured to heat the aerosol-generating article.

Aerosol-generating articles in which an aerosol-generating substrate, such as a tobacco-containing material, is heated rather than combusted, are known in the art. An aim of such ‘heated’ aerosol-generating articles is to reduce known harmful smoke constituents of the type produced by the combustion and pyrolytic degradation of tobacco in conventional cigarettes.

Typically in heated aerosol-generating articles, an aerosol is generated by the transfer of heat from a heat source to a physically separate aerosol-generating substrate. In use, volatile compounds are released from the aerosol-generating substrate by heat transfer to the aerosol-generating substrate from the heat source and entrained in air drawn through the aerosol-generating article. As the released compounds cool, they condense to form an aerosol that is inhaled by the user.

A number of handheld aerosol-generating devices configured to heat aerosol-generating substrates of heated aerosol-generating articles are known in the art. These include electrically-operated aerosol-generating devices in which an aerosol is generated by the transfer of heat from one or more electrical heating elements of the aerosol-generating device to the aerosol-generating substrate of the heated aerosol-generating article. Known handheld electrically operated aerosol-generating devices typically comprise a battery, control electronics and one or more electrical heating elements for heating the aerosol-generating substrate of a heated aerosol-generating article designed specifically for use with the aerosol-generating device.

Some known electrically-operated aerosol-generating devices comprise an internal heating element that is configured to be inserted into the aerosol-generating substrate of a heated aerosol-generating article. Other known electrically-operated aerosol-generating devices comprise one or more external heating elements. For example, WO 2020/115151 A1 discloses an aerosol-generating system comprising an aerosol-generating article and an electrically-operated aerosol-generating device comprising an external heating element that circumscribes the outer periphery of the aerosol-generating article.

Electrically-operated aerosol-generating devices comprising an inductor configured to inductively heat aerosol-generating substrates of heated aerosol-generating articles are also known in the art. For example, WO 2015/176898 A1 discloses an aerosol-generating system comprising an aerosol-generating article comprising an elongate susceptor in thermal contact with the aerosol-generating substrate and an electrically-operated aerosol-generating device having an inductor for heating the aerosol-generating substrate. In use, the fluctuating or alternating electromagnetic field produced by the inductor induces eddy currents in the susceptor, causing the susceptor to heat up as a result of one or both of resistive losses (Joule heating) and, where the susceptor is magnetic, hysteresis losses. Heat generated in the susceptor is transferred to the aerosol-forming substrate by conduction.

Heated aerosol-generating articles comprising two or more physically separate aerosol-generating substrates for use with electrically-operated aerosol-generating devices have been proposed in the art. Typically the two or more physically separate aerosol-generating substrates of such heated aerosol-generating articles are heated simultaneously by the electrically-operated aerosol-generating device. This may disadvantageously result in generation of an inhalable aerosol comprising uncontrolled and variable proportions of volatile compounds released from each of the two or more physically separate aerosol-generating substrates.

It would be desirable to provide a heated aerosol-generating article comprising dual aerosol-generating substrates for use with an electrically-operated aerosol-generating device that allows delivery to a user of an inhalable aerosol comprising controlled proportions of volatile compounds released from each of the dual aerosol-generating substrates.

The invention relates to an aerosol-generating article for generating an inhalable aerosol upon heating. The aerosol-generating article may have a proximal end and a distal end. The aerosol-generating article may comprise a first aerosol-generating substrate. The first aerosol-generating substrate may be located between the distal end and the proximal end of the aerosol-generating article. The aerosol-generating article may comprise a first air inlet for admitting air into the aerosol-generating article. The aerosol-generating article may comprise a second aerosol-generating substrate. The second aerosol-generating substrate may be located between the first aerosol-generating substrate and the proximal end of the aerosol-generating article. The aerosol-generating article may comprise a second air inlet for admitting air into the aerosol-generating article. The aerosol-generating article may comprise a first airflow pathway extending from the first air inlet through the first aerosol-generating substrate towards the proximal end of the aerosol-generating article. The aerosol-generating article may comprise a second airflow pathway extending from the second air inlet through the second aerosol-generating substrate towards the proximal end of the aerosol-generating article. The first airflow pathway and the second airflow pathway may be isolated from one another.

The invention also relates to an aerosol-generating system. The aerosol-generating system may comprise an aerosol-generating article as described above. The aerosol-generating system may comprise an aerosol-generating device. The aerosol-generating device may be configured to heat the first aerosol-generating substrate and the second aerosol-generating substrate of the aerosol-generating article.

According to a first aspect of the invention there is provided an aerosol-generating article for generating an inhalable aerosol upon heating, the aerosol-generating article having a proximal end and a distal end and comprising: a first aerosol-generating substrate located between the distal end and the proximal end of the aerosol-generating article; a first air inlet for admitting air into the aerosol-generating article; a second aerosol-generating substrate located between the first aerosol-generating substrate and the proximal end of the aerosol-generating article; a second air inlet for admitting air into the aerosol-generating article; a first airflow pathway extending from the first air inlet through the first aerosol-generating substrate towards the proximal end of the aerosol-generating article; and a second airflow pathway extending from the second air inlet through the second aerosol-generating substrate towards the proximal end of the aerosol-generating article, wherein the first airflow pathway and the second airflow pathway are isolated from one another.

According to a second aspect of the invention there is provided an aerosol-generating system comprising: an aerosol-generating article according to the first aspect of the invention; and an aerosol-generating device configured to heat the first aerosol-generating substrate and the second aerosol-generating substrate of the aerosol-generating article.

As used herein with reference to the invention, the term “aerosol-generating article” is used to describe an article comprising an aerosol-generating substrate that is heated to generate an inhalable aerosol for delivery to a user.

As used herein with reference to the invention, the term “aerosol-generating substrate” is used to describe a substrate comprising aerosol-forming material that is capable of releasing upon heating volatile compounds that can generate an aerosol.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein with reference to the invention, the term “aerosol-generating device” is used to describe a device that interacts with the aerosol generating substrate of the aerosol generating article to generate an aerosol.

Aerosol-generating articles according to the first aspect of the invention comprise a first airflow pathway extending from the first air inlet through the first aerosol-generating substrate towards the proximal end of the aerosol-generating article and a second airflow pathway extending from the second air inlet through the second aerosol-generating substrate towards the proximal end of the aerosol-generating article.

As used herein with reference to the invention, the term “airflow pathway” is used to describe a route along which air may be drawn through an aerosol-generating article according to the first aspect of the invention.

In use, volatile compounds released from the first aerosol-generating substrate upon heating of the first aerosol-generating substrate are entrained in air drawn along the first airflow pathway.

In use, volatile compounds released from the second aerosol-generating substrate upon heating of the second aerosol-generating substrate are entrained in air drawn along the second airflow pathway.

The first airflow pathway and the second airflow pathway are isolated from one another.

As used herein with reference to the invention, the term “isolated” means that, in use, air being drawn along the first airflow pathway cannot mix with air being drawn along the second airflow pathway and air being drawn along the second airflow pathway cannot mix with air being drawn along the first airflow pathway.

As described further below, isolation of the first airflow pathway and the second airflow pathway from one another in aerosol-generating articles according to the first aspect of the invention advantageously enables delivery to a user of an inhalable aerosol comprising controlled proportions of volatile compounds released from each of the first aerosol-generating substrate and the second aerosol-generating substrate.

Aerosol-generating articles according to the first aspect of the invention have a proximal end through which, in use, an aerosol exits the aerosol-generating article for delivery to a user. The proximal end of the aerosol-generating article may also be referred to as the mouth end of the aerosol-generating article. In use, a user draws on the proximal end of the aerosol-generating article in order to inhale an aerosol generated by the aerosol-generating article.

Aerosol-generating articles according to the first aspect of the invention have a distal end. The distal end is opposite the proximal end.

Components of aerosol-generating articles according to the first aspect of the invention may be described as being upstream or downstream of one another based on their relative positions between the proximal end of the aerosol-generating article and the distal end of the aerosol-generating article.

The first aerosol-generating substrate is located between the distal end and the proximal end of the aerosol-generating article.

The second aerosol-generating substrate is located between the first aerosol-generating substrate and the proximal end of the aerosol-generating article.

The second aerosol-generating substrate may be described as being downstream of the first aerosol-generating substrate.

As used herein with reference to the invention, the term “axial” is used to describe the direction between the proximal end and the distal end of aerosol-generating articles according to the first aspect of the invention.

As used herein with reference to the invention, the term “radial” is used to describe the direction perpendicular to the axial direction. That is, the direction perpendicular to the direction between the proximal end and the distal end of aerosol-generating articles according to the first aspect of the invention.

As used herein with reference to the invention, the term “length” is used to describe the maximum dimension of aerosol-generating articles according to the first aspect of the invention and components of aerosol-generating articles according to the first aspect of the invention in the axial direction. That is, the maximum dimension of aerosol-generating articles according to the first aspect of the invention and components of aerosol-generating articles according to the first aspect of the invention in the direction between the proximal end and the distal end of aerosol-generating articles according to the first aspect of the invention.

As used herein with reference to the invention, the term “width” is used to describe the maximum dimension of aerosol-generating articles according to the first aspect of the invention and components of aerosol-generating articles according to the first aspect of the invention in the radial direction. That is, the maximum dimension of aerosol-generating articles according to the first aspect of the invention and components of aerosol-generating articles according to the first aspect of the invention in the direction perpendicular to the direction between the proximal end and the distal end of aerosol-generating articles according to the first aspect of the invention.

The aerosol-generating article may comprise one or more components upstream of the first aerosol-generating substrate. That is, the aerosol-generating article may comprise one or more components located between the first aerosol-generating substrate and the distal end of the aerosol-generating article. Components located between the first aerosol-generating substrate and the distal end of the aerosol-generating article are subsequently referred to herein as “upstream components”.

The aerosol-generating article may comprise one or more air-permeable upstream components. For example, the aerosol-generating article may comprise one or more air-permeable plugs of porous material located between the first aerosol-generating substrate and the distal end of the aerosol-generating article. The one or more air-permeable plugs may comprise any suitable porous material including, but not limited to, cellulose acetate, cotton, paper, and porous plastic.

The first airflow pathway may extend through the one or more air-permeable upstream components.

The aerosol-generating article may comprise an air-permeable upstream component located at the distal end of the aerosol-generating article. For example, the aerosol-generating article may comprise an air-permeable plug of porous material located at the distal end of the aerosol-generating article.

The first airflow pathway may extend through the air-permeable upstream component located at the distal end of the aerosol-generating article.

The first aerosol-generating substrate may be located proximate to the distal end of the aerosol-generating article.

The first aerosol-generating substrate may be located at the distal end of the aerosol-generating article.

The aerosol-generating article may comprise one or more components located between the first aerosol-generating substrate and the second aerosol-generating substrate of the aerosol-generating article. Components located between the first aerosol-generating substrate and the distal end of the aerosol-generating article are subsequently referred to herein as “intermediate components” of the aerosol-generating article.

The aerosol-generating article may comprise one or more tubular intermediate components. For example, the aerosol-generating article may comprise one or more hollow tubular elements located between the first aerosol-generating substrate and the second aerosol-generating substrate of the aerosol-generating article. The one or more hollow tubular elements may comprise any suitable material including, but not limited to, plastic.

The first airflow pathway may extend through the one or more tubular intermediate components.

The aerosol-generating article may comprise a first hollow tubular element located between the first aerosol-generating substrate and the second aerosol-generating substrate of the aerosol-generating article.

The first hollow tubular element may comprise an axial airflow channel circumscribed by an air-impermeable wall.

The first airflow pathway may extend through the axial airflow channel of the first hollow tubular element.

An axial airflow channel may be provided in the second aerosol-generating substrate.

The first airflow pathway may extend through the axial airflow channel provided in the second aerosol-generating substrate.

The aerosol-generating article may comprise one or more components downstream of the second aerosol-generating substrate. That is, the aerosol-generating article may comprise one or more components located between the second aerosol-generating substrate and the proximal end of the aerosol-generating article. Components located between the second aerosol-generating substrate and the proximal end of the aerosol-generating article are subsequently referred to herein as “downstream components”.

The aerosol-generating article may comprise one or more tubular downstream components. For example, the aerosol-generating article may comprise one or more hollow tubular elements located between the second aerosol-generating substrate and the proximal end of the aerosol-generating article. The one or more hollow tubular elements may comprise any suitable material including, but not limited to, cellulose based material, bio-polymeric material, and paper.

The first airflow pathway may extend through the one or more tubular downstream components and the second airflow pathway may extend through the one or more tubular downstream components.

The aerosol-generating article may comprise a second hollow tubular element located between the second aerosol-generating substrate and the proximal end of the aerosol-generating article.

The second hollow tubular element may comprise a first axial airflow channel and a second axial airflow channel.

The first airflow pathway may extend through the first axial airflow channel of the second hollow tubular element and the second airflow pathway may extend through the second axial airflow channel of the second hollow tubular element.

The second hollow tubular element may comprise an inner axial airflow channel and an outer axial airflow channel.

The first airflow pathway may extend through the inner axial airflow channel of the second hollow tubular element and the second airflow pathway may extend through the outer axial airflow channel of the second hollow tubular element towards the proximal end of the aerosol-generating article.

The first airflow pathway may extend to the proximal end of the aerosol-generating article and the second airflow pathway may extend to the proximal end of the aerosol-generating article.

Where the first airflow pathway extends to the proximal end of the aerosol-generating article and the second airflow pathway extends to the proximal end of the aerosol-generating article, in use, a first inhalable aerosol comprising volatile compounds released from the first aerosol-generating substrate upon heating of the first aerosol-generating substrate and entrained in air drawn along the first airflow pathway may exit the aerosol-generating article through the proximal end of the aerosol-generating article for delivery to a user and a second inhalable aerosol comprising volatile compounds released from the second aerosol-generating substrate upon heating of the second aerosol-generating substrate and entrained in air drawn along the second airflow pathway may exit the aerosol-generating article through the proximal end of the aerosol-generating article for delivery to a user. The first inhalable aerosol and the second inhalable aerosol may mix inside the mouth of a user during inhalation by a user.

The first airflow pathway and the second airflow pathway may not extend to the proximal end of the aerosol-generating article. The aerosol-generating article may comprise a third airflow pathway that extends from the first airflow pathway and the second airflow pathway to the proximal end of the aerosol-generating article.

Where the aerosol-generating article comprises a third airflow pathway that extends from the first airflow pathway and the second airflow pathway to the proximal end of the aerosol-generating article, in use, a first inhalable aerosol comprising volatile compounds released from the first aerosol-generating substrate upon heating of the first aerosol-generating substrate and entrained in air drawn along the first airflow pathway may be drawn along the third airflow pathway and a second inhalable aerosol comprising volatile compounds released from the second aerosol-generating substrate upon heating of the second aerosol-generating substrate and entrained in air drawn along the second airflow pathway may be drawn along the third airflow pathway. As the first inhalable aerosol and the second inhalable aerosol are drawn along the third airflow pathway, the first inhalable aerosol and the second inhalable aerosol may mix to form a combined inhalable aerosol that may exit the aerosol-generating article through the proximal end of the aerosol-generating article for delivery to a user.

The aerosol-generating article may comprise a mixing chamber downstream of the second aerosol-generating substrate. That is, the aerosol-generating article may comprise a mixing chamber located between the second aerosol-generating substrate and the proximal end of the aerosol-generating article.

The first airflow pathway may extend from the first air inlet through the first aerosol-generating substrate to the mixing chamber and the second airflow pathway may extend from the second air inlet through the second aerosol-generating substrate to the mixing chamber. The third airflow pathway may extend from the first airflow pathway and the second airflow pathway through the mixing chamber to the proximal end of the aerosol-generating article.

Where the aerosol-generating article comprises a mixing chamber downstream of the second aerosol-generating substrate, in use, a first inhalable aerosol comprising volatile compounds released from the first aerosol-generating substrate upon heating of the first aerosol-generating substrate and entrained in air drawn along the first airflow pathway may be drawn into the mixing chamber and a second inhalable aerosol comprising volatile compounds released from the second aerosol-generating substrate upon heating of the second aerosol-generating substrate and entrained in air drawn along the second airflow pathway may be drawn into the mixing chamber. The first inhalable aerosol and the second inhalable aerosol may mix inside the mixing chamber to form a combined inhalable aerosol that may exit the aerosol-generating article through the proximal end of the aerosol-generating article for delivery to a user.

The aerosol-generating article may comprise one or more components downstream of the mixing chamber. That is, the aerosol-generating article may comprise one or more components located between the mixing chamber and the proximal end of the aerosol-generating article. Components located between the mixing chamber and the proximal end of the aerosol-generating article are subsequently referred to herein as “mouth end components”.

The aerosol-generating article may comprise one or more air-permeable mouth end components. For example, the aerosol-generating article may comprise one or more air-permeable plugs of porous material located between the mixing chamber and the proximal end of the aerosol-generating article. The one or more air-permeable plugs may comprise any suitable porous material including, but not limited to, cellulose acetate, cotton, paper, and porous plastic.

The third airflow pathway may extend through the one or more air-permeable mouth end components.

The aerosol-generating article may comprise a mouthpiece located at the proximal end of the aerosol-generating article. For example, the aerosol-generating article may comprise a mouthpiece comprising a plug of porous material located at the proximal end of the aerosol-generating article.

The third airflow pathway may extend through the mouthpiece.

The first airflow pathway may have any desired length.

The first airflow pathway may have a length of at least about 15 mm, at least about 20 mm or at least about 25 mm.

The first airflow pathway may have a length of less than or equal to about 55 mm, less than or equal to about 50 mm or less than or equal to about 45 mm.

The first airflow pathway may have a length of between about 15 mm and about 55 mm, between about 15 mm and about 50 mm or between about 15 mm and about 45 mm.

The first airflow pathway may have a length of between about 20 mm and about 55 mm, between about 20 mm and about 50 mm or between about 20 mm and about 45 mm.

The first airflow pathway may have a length of between about 25 mm and about 55 mm, between about 25 mm and about 50 mm or between about 25 mm and about 45 mm.

The second airflow pathway may have any desired length.

The second airflow pathway may have a length of at least about 10 mm, at least about 12 mm or at least about 14 mm.

The second airflow pathway may have a length of less than or equal to about 30 mm, less than or equal to about 28 mm or less than or equal to about 26 mm.

The second airflow pathway may have a length of between about 10 mm and about 30 mm, between about 10 mm and about 28 mm or between about 10 mm and about 26 mm.

The second airflow pathway may have a length of between about 12 mm and about 30 mm, between about 12 mm and about 28 mm or between about 12 mm and about 26 mm.

The second airflow pathway may have a length of between about 14 mm and about 30 mm, between about 14 mm and about 28 mm or between about 14 mm and about 26 mm.

A ratio of the length of the first airflow pathway to the length of the second airflow pathway may be at least about 1.2, at least about 1.3, at least about 1.4 or at least about 1.5.

A ratio of the length of the first airflow pathway to the length of the second airflow pathway may be less than or equal to about 2.5, less than or equal to about 2.3, less than or equal to about 2.1 or less than or equal to about 1.9.

A ratio of the length of the first airflow pathway to the length of the second airflow pathway may be between about 1.2 and about 2.5, between about 1.2 and about 2.3, between about 1.2 and about 2.1 or between about 1.2 and about 1.9.

A ratio of the length of the first airflow pathway to the length of the second airflow pathway may be between about 1.3 and about 2.5, between about 1.3 and about 2.3, between about 1.3 and about 2.1 or between about 1.3 and about 1.9.

A ratio of the length of the first airflow pathway to the length of the second airflow pathway may be between about 1.4 and about 2.5, between about 1.4 and about 2.3, between about 1.4 and about 2.1 or between about 1.4 and about 1.9.

A ratio of the length of the first airflow pathway to the length of the second airflow pathway may be between about 1.5 and about 2.5, between about 1.5 and about 2.3, between about 1.5 and about 2.1 or between about 1.5 and about 1.9.

The third airflow pathway may have any desired length.

The third airflow pathway may have a length of at least about 2 mm, at least about 4 mm or at least about 6 mm.

The third airflow pathway may have a length of less than or equal to about 14 mm, less than or equal to about 12 mm or less than or equal to about 10 mm.

The third airflow pathway may have a length of between about 2 mm and about 14 mm, between about 2 mm and about 12 mm or between about 2 mm and about 10 mm.

The third airflow pathway may have a length of between about 4 mm and about 14 mm, between about 4 mm and about 12 mm or between about 4 mm and about 10 mm.

The third airflow pathway may have a length of between about 6 mm and about 14 mm, between about 6 mm and about 12 mm or between about 6 mm and about 10 mm.

The mouthpiece may have any desired transverse cross-section. For example, the mouthpiece may have a substantially circular, oval or elliptical transverse cross-section.

The mouthpiece may have any desired length. For example, the mouthpiece may have a length of between about 3 mm and about 6 mm.

The mouthpiece may have any desired width. For example, the mouthpiece may have a width of between about 5 millimetres and about 11 millimetres. The mouthpiece may have a width that is substantially the same as the width of the aerosol-generating article.

The mixing chamber may be located proximate to the proximal end of the aerosol-generating article.

The mixing chamber may be located at the proximal end of the aerosol-generating article.

The mixing chamber may be a cavity or recess at the proximal end of the aerosol-generating article.

The mixing chamber may have any desired shape. For example, the mixing chamber may be substantially cylindrical.

The mixing chamber may have any desired transverse cross-section. For example, the mixing chamber may have a substantially circular, oval or elliptical transverse cross-section.

The mixing chamber may have any desired length. For example, the mixing chamber may have a length of between about 4 mm and about 7 mm.

The mixing chamber may have any desired width. For example, the mixing chamber may have a width of between about 5 millimetres and about 11 millimetres. The mixing chamber may have a width that is substantially the same as the width of the aerosol-generating article.

The mixing chamber may be defined by one or more wrappers of the aerosol-generating article that circumscribe the mixing chamber and one or more other components of the aerosol-generating article.

The first air inlet and the second air inlet are physically separate from one another.

The first air inlet may be located at the distal end of the aerosol-generating article.

The second air inlet may be located downstream of the first air inlet. That is, the second air inlet may be located between the first air inlet and the proximal end of the aerosol-generating article.

The first air inlet may be configured to admit air into the aerosol-generating article in an axial direction.

The first air inlet may be configured to admit air into the aerosol-generating article in a radial direction.

The second air inlet may be configured to admit air into the aerosol-generating article in an axial direction.

The second air inlet may be configured to admit air into the aerosol-generating article in a radial direction.

The first air inlet may be configured to admit air into the aerosol-generating article in the same direction as the second air inlet. For example, the first air inlet may be configured to admit air into the aerosol-generating article in an axial direction and the second air inlet may be configured to admit air into the aerosol-generating article in an axial direction.

The first air inlet may be configured to admit air into the aerosol-generating article in a different direction to the second air inlet. For example, the first air inlet may be configured to admit air into the aerosol-generating article in an axial direction and the second air inlet may be configured to admit air into the aerosol-generating article in a radial direction.

The first air inlet may be located about a periphery of the first aerosol-generating substrate. For example, the first air inlet may be located at a distal end of the first aerosol-generating substrate.

The first air inlet may be configured to admit air directly into the first aerosol-generating substrate. For example, the first air inlet may be configured to admit air directly into the first aerosol-generating substrate in an axial direction.

The second air inlet may be located about a periphery of the second aerosol-generating substrate. For example, the second air inlet may be located between a distal end and a proximal end of the second aerosol-generating substrate.

The second air inlet may be configured to admit air directly into the second aerosol-generating substrate. For example, the second air inlet may be configured to admit air directly into the second aerosol-generating substrate in a radial direction.

The first aerosol-generating substrate and the second aerosol-generating substrate are physically separate from one another.

The composition of the first aerosol-generating substrate may be the same as the composition of the second aerosol-generating substrate.

The composition of the first aerosol-generating substrate may be different to the composition of the second aerosol-generating substrate.

One or both of the first aerosol-generating substrate and the second aerosol-generating substrate may comprise nicotine. That is, the first aerosol-generating substrate may comprise nicotine or the second aerosol-generating substrate may comprise nicotine or the first aerosol-generating substrate and the second aerosol-generating substrate may each comprise nicotine.

As used herein with reference to the invention, the term “nicotine” is used to describe nicotine and nicotine derivatives such as nicotine salts.

One or both of the first aerosol-generating substrate and the second aerosol-generating substrate may comprise tobacco material. That is, the first aerosol-generating substrate may comprise tobacco material or the second aerosol-generating substrate may comprise tobacco material or the first aerosol-generating substrate and the second aerosol-generating substrate may each comprise tobacco material.

As used herein with reference to the invention, the term “tobacco material” is used to describe any material comprising tobacco, including, but not limited to, tobacco leaf, tobacco rib, tobacco stem, tobacco stalk, tobacco dust, expanded tobacco, reconstituted tobacco material and homogenised tobacco material.

One or both of the first aerosol-generating substrate and the second aerosol-generating substrate may comprise homogenised tobacco material. That is, the first aerosol-generating substrate may comprise homogenised tobacco material or the second aerosol-generating substrate may comprise homogenised tobacco material or the first aerosol-generating substrate and the second aerosol-generating substrate may each comprise homogenised tobacco material.

As used herein with reference to the invention, the term “homogenised tobacco material” is used to describe a material formed by agglomerating particulate tobacco.

The tobacco material may, for example, be in the form of powder, granules, pellets, shreds, strands, strips, sheets or any combination thereof.

One or both of the first aerosol-generating substrate and the second aerosol-generating substrate may comprise one or more aerosol formers. That is, the first aerosol-generating substrate may comprise one or more aerosol formers or the second aerosol-generating substrate may comprise one or more aerosol formers or the first aerosol-generating substrate and the second aerosol-generating substrate may each comprise one or more aerosol formers.

The aerosol former may be any suitable compound or mixture of compounds that, in use, facilitates formation of a dense and stable aerosol and that is substantially resistant to thermal degradation at the operating temperature of an aerosol-generating system comprising the aerosol-generating article. Suitable aerosol formers are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate.

One or both of the first aerosol-generating substrate and the second aerosol-generating substrate may comprise one or more flavourants. That is, the first aerosol-generating substrate may comprise one or more flavourants or the second aerosol-generating substrate may comprise one or more flavourants or the first aerosol-generating substrate and the second aerosol-generating substrate may each comprise one or more flavourants.

Suitable flavourants are known in the art and include, but are not limited to, menthol.

The first aerosol-generating substrate may comprise solid aerosol-forming material, liquid aerosol-forming material, gel aerosol-forming material or a combination thereof.

The first aerosol-generating substrate may comprise solid aerosol-forming material, liquid aerosol-forming material, gel aerosol-forming material or a combination thereof.

The first aerosol-generating substrate may comprise a plug of solid aerosol-forming material circumscribed by a wrapper.

The first aerosol-generating substrate may comprise a porous substrate loaded with liquid aerosol-forming material, gel aerosol-forming material, or a combination thereof.

The second aerosol-generating substrate may comprise a plug of solid aerosol-forming material circumscribed by a wrapper.

The second aerosol-generating substrate may comprise solid aerosol-forming material, liquid aerosol-forming material, gel aerosol-forming material or a combination thereof.

The second aerosol-generating substrate may comprise a porous substrate loaded with liquid aerosol-forming material, gel aerosol-forming material, or a combination thereof.

The aerosol-generating article may have any desired shape. For example, the aerosol-generating article may be substantially cylindrical.

The aerosol-generating article may have any desired transverse cross-section. For example, the aerosol-generating article may have a substantially circular, oval or elliptical transverse cross-section.

The aerosol-generating article may have any desired length. For example, the aerosol-generating article may have a length of between about 50 millimetres and about 90 millimetres.

The aerosol-generating article may have any desired width. For example, the aerosol-generating article may have a width of between about 5 millimetres and about 12 millimetres.

The first aerosol-generating substrate may have any desired shape. For example, the first aerosol-generating substrate may be substantially cylindrical.

The first aerosol-generating substrate may have any desired transverse cross-section. For example, the first aerosol-generating substrate may have a substantially circular, oval or elliptical transverse cross-section.

The first aerosol-generating substrate may have any desired length. For example, the first aerosol-generating substrate may have a length of between about 7 mm and about 13 mm.

The first aerosol-generating substrate may have any desired width. For example, the first aerosol-generating substrate may have a width of between about 5 millimetres and about 11 millimetres. The first aerosol-generating substrate may have a width that is substantially the same as the width of the aerosol-generating article.

The second aerosol-generating substrate may have any desired shape. For example, the second aerosol-generating substrate may be substantially cylindrical.

The second aerosol-generating substrate may have any desired transverse cross-section. For example, the second aerosol-generating substrate may have a substantially circular, oval or elliptical transverse cross-section.

The second aerosol-generating substrate may have any desired length. For example, the first aerosol-generating substrate may have a length of between about 7 mm and about 13 mm.

The second aerosol-generating substrate may have any desired width. For example, the first aerosol-generating substrate may have a width of between about 5 millimetres and about 11 millimetres. The first aerosol-generating substrate may have a width that is substantially the same as the width of the aerosol-generating article.

The first aerosol-generating substrate, the second aerosol-generating substrate and other components of the aerosol-generating article may be assembled within one or more wrappers to form the aerosol-generating article. For example, the first aerosol-generating substrate, the second aerosol-generating substrate and other components of the aerosol-generating article may be assembled within one or more wrappers to form an elongate rod.

Suitable wrappers for use in aerosol-generating articles according to the first aspect of the invention are known in the art and include, but are not limited to: cigarette papers; filter plug wraps; tipping papers; metallised papers; metal foils; and metal foil-paper laminates.

Aerosol-generating articles according to the first aspect of the invention may resemble conventional lit-end cigarettes.

According to a second aspect of the invention there is provided an aerosol-generating system comprising: an aerosol-generating article according to the first aspect of the invention; and an aerosol-generating device configured to heat the first aerosol-generating substrate and the second aerosol-generating substrate of the aerosol-generating article.

The aerosol-generating device may be configured to heat the first aerosol-generating substrate and the second aerosol-generating substrate of the aerosol-generating article simultaneously.

The aerosol-generating device may be configured to heat the first aerosol-generating substrate and the second aerosol-generating substrate of the aerosol-generating article sequentially.

The aerosol-generating device may be configured to heat the first aerosol-generating substrate and the second aerosol-generating substrate of the aerosol-generating article to the same temperature.

The aerosol-generating device may be configured to heat the first aerosol-generating substrate and the second aerosol-generating substrate of the aerosol-generating article to different temperatures.

The aerosol-generating device may comprise a housing defining a device cavity configured to receive at least a portion of the aerosol-generating article.

The aerosol-generating device may be a handheld aerosol-generating device.

The aerosol-generating device may be an electrically-operated aerosol-generating device.

The aerosol-generating device may comprise a power supply and control electronics.

The aerosol-generating device may comprise a battery and control electronics.

The aerosol-generating device may comprise an electric heater.

The aerosol-generating device may comprise an electric heater comprising one or more heating elements.

The aerosol-generating device may comprise an electric heater comprising one or more resistive heating elements.

The aerosol-generating device may comprise an electric heater comprising a first heating element configured to heat the first aerosol-generating substrate of the aerosol-generating article and a second heating element configured to heat the second aerosol-generating substrate of the aerosol-generating article.

The aerosol-generating device may comprise an electric heater comprising a first resistive heating element configured to heat the first aerosol-generating substrate of the aerosol-generating article and a second resistive heating element configured to heat the second aerosol-generating substrate of the aerosol-generating article.

One or both of the aerosol-generating article and the aerosol-generating device may comprise one or more susceptors. That is, the aerosol-generating article may comprise one or more susceptors or the aerosol-generating device may comprise one or more susceptors or the aerosol-generating article and the aerosol-generating device may each comprise one or more susceptors.

The aerosol-generating article may comprise a single susceptor configured to heat the first aerosol-generating substrate of the aerosol-generating article and the second aerosol-generating substrate of the aerosol-generating article.

The aerosol-generating article may comprise a single susceptor in thermal contact with the first aerosol-generating substrate of the aerosol-generating article and the second aerosol-generating substrate of the aerosol-generating article.

The aerosol-generating article may comprise a first susceptor configured to heat the first aerosol-generating substrate of the aerosol-generating article and a second susceptor configured to heat the second aerosol-generating substrate of the aerosol-generating article.

The aerosol-generating article may comprise a first susceptor in thermal contact with the first aerosol-generating substrate and a second susceptor in thermal contact with the second aerosol-generating substrate.

The aerosol-generating device may comprise a single susceptor configured to heat the first aerosol-generating substrate of the aerosol-generating article and the second aerosol-generating substrate of the aerosol-generating article.

The aerosol-generating device may comprise a first susceptor configured to heat the first aerosol-generating substrate of the aerosol-generating article and a second susceptor configured to heat the second aerosol-generating substrate of the aerosol-generating article.

The aerosol-generating device may comprise an inductor.

The aerosol-generating device may comprise an inductor comprising one or more induction coils.

The aerosol-generating device may comprise an inductor comprising a first induction coil and a second induction coil.

The aerosol-generating device may comprise an inductor comprising a first induction coil configured to heat a first susceptor and a second induction coil configured to heat a second susceptor.

Where the aerosol-generating article comprises a first susceptor and a second susceptor, the aerosol-generating device may comprise an inductor comprising a first induction coil configured to heat the first susceptor of the aerosol-generating article and a second induction coil configured to heat the second susceptor of the aerosol-generating article.

Where the aerosol-generating device comprises a first susceptor and a second susceptor, the aerosol-generating device may comprise an inductor comprising a first induction coil configured to heat the first susceptor of the aerosol-generating device and a second induction coil configured to heat the second susceptor of the aerosol-generating device.

Below, there is provided a non-exhaustive list of non-limiting examples. Any one or more of the features of these examples may be combined with any one or more features of another example, embodiment, or aspect described herein.

EX1: An aerosol-generating article for generating an inhalable aerosol upon heating, the aerosol-generating article having a proximal end and a distal end and comprising: a first aerosol-generating substrate located between the distal end and the proximal end of the aerosol-generating article; a first air inlet for admitting air into the aerosol-generating article; a second aerosol-generating substrate located between the distal end and the proximal end of the aerosol-generating article; a second air inlet for admitting air into the aerosol-generating article; a first airflow pathway extending from the first air inlet through the first aerosol-generating substrate towards the proximal end of the aerosol-generating article; and a second airflow pathway extending from the second air inlet through the second aerosol-generating substrate towards the proximal end of the aerosol-generating article, wherein the first airflow pathway and the second airflow pathway are isolated from one another.

EX2: An aerosol-generating article according to example EX1 wherein the second aerosol-generating substrate is located between the first aerosol-generating substrate and the proximal end of the aerosol-generating article.

EX3: An aerosol-generating article according to example EX1 or EX2 wherein the first air inlet is configured to admit air into the aerosol-generating article in an axial direction.

EX4: An aerosol-generating article according to example EX1 or EX2 wherein the first air inlet is configured to admit air into the aerosol-generating article in a radial direction.

EX5: An aerosol-generating article according to any one of examples EX1 to EX4 wherein the first air inlet is located about a periphery of the first aerosol-generating substrate of the aerosol-generating article.

EX6: An aerosol-generating article according to any one of examples EX1 to EX5 wherein the first air inlet is located at a distal end of the first aerosol-generating substrate of the aerosol-generating article.

EX7: An aerosol-generating article according to any one of examples EX1 to EX6 wherein the first air inlet is configured to admit air directly into the first aerosol-generating substrate of the aerosol-generating article.

EX8: An aerosol-generating article according to any one of examples EX1 to EX7 wherein the second air inlet is configured to admit air into the aerosol-generating article in an axial direction.

EX9: An aerosol-generating article according to any one of examples EX1 to EX7 wherein the second air inlet is configured to admit air into the aerosol-generating article in a radial direction.

EX10: An aerosol-generating article according to any one of examples EX1 to EX9 wherein the second air inlet is located about a periphery of the second aerosol-generating substrate.

EX11: An aerosol-generating article according to any one of examples EX1 to EX10 wherein the second air inlet is configured to admit air directly into the second aerosol-generating substrate.

EX12: An aerosol-generating article according to any one of examples EX1 to EX11 wherein an axial airflow channel is provided in the second aerosol-generating substrate.

EX13: An aerosol-generating article according to any one of examples EX1 to EX12 wherein the first airflow pathway extends through the axial airflow channel provided in the second aerosol-generating substrate.

EX14: An aerosol-generating article according to any one of examples EX1 to EX13 comprising one or more components located between the first aerosol-generating substrate and the second aerosol-generating substrate.

EX15: An aerosol-generating article according to any one of examples EX1 to EX14 comprising a first hollow tubular element located between the first aerosol-generating substrate and the second aerosol-generating substrate.

EX16: An aerosol-generating article according to example EX15 wherein the first hollow tubular element comprises an axial airflow channel and an air impermeable wall.

EX17: An aerosol-generating article according to example EX16 wherein the first airflow pathway extends through the axial airflow channel of the first hollow tubular element.

EX18: An aerosol-generating article according to any one of examples EX1 to EX17 comprising one or more components located between the second aerosol-generating substrate and the proximal end of the aerosol-generating article.

EX19: An aerosol-generating article according to any one of examples EX1 to EX18 comprising a second hollow tubular element located between the second aerosol-generating substrate and the proximal end of the aerosol-generating article.

EX20: An aerosol-generating article according to example EX19 wherein the second hollow tubular element comprises a first axial airflow channel and a second axial airflow channel.

EX21: An aerosol-generating article according to example EX20 wherein the first airflow pathway extends through the first axial channel of the second hollow tubular element and the second airflow pathway extends through the second axial airflow channel of the second hollow tubular element.

EX22: An aerosol-generating article according to example EX19 wherein the second hollow tubular element comprises an inner axial airflow channel and an outer axial airflow channel.

EX23: An aerosol-generating article according to example EX22 wherein the first airflow pathway extends through the inner axial channel of the second hollow tubular element and the second airflow pathway extends through the outer axial airflow channel of the second hollow tubular element.

EX24: An aerosol-generating article according to any one of examples EX1 to EX23 wherein the first airflow pathway extends to the proximal end of the aerosol-generating article.

EX25: An aerosol-generating article according to any one of examples EX1 to EX24 wherein the second airflow pathway extends to the proximal end of the aerosol-generating article.

EX26: An aerosol-generating article according to any one of examples EX1 to EX23 comprising a mixing chamber located between the second aerosol-generating substrate and the proximal end of the aerosol-generating article.

EX27: An aerosol-generating article according to example EX26 wherein the first airflow pathway extends from the first air inlet through the first aerosol-generating substrate to the mixing chamber and the second airflow pathway extends from the second air inlet through the second aerosol-generating substrate to the mixing chamber.

EX28: An aerosol-generating article according to example EX26 or EX27 wherein the mixing chamber is located at the proximal end of the aerosol-generating article.

EX29: An aerosol-generating article according to example EX26 or EX27 comprising one or more components located between the mixing chamber and the proximal end of the aerosol-generating article.

EX30: An aerosol-generating article according to any one of examples EX1 to EX29 wherein the first aerosol-generating substrate is located at the distal end of the aerosol-generating article.

EX31: An aerosol-generating article according to any one of examples EX1 to EX29 comprising one or more components located between the first aerosol-generating substrate and the distal end of the aerosol-generating article.

EX32: An aerosol-generating article according to any one of examples EX1 to EX31 comprising one or more air-permeable components located between the first aerosol-generating substrate and the distal end of the aerosol-generating article.

EX33: An aerosol-generating article according to example EX32 wherein the first airflow pathway extends through the one or more air-permeable components.

EX34: An aerosol-generating article according to any one of examples EX1 to EX32 comprising an air-permeable plug of porous material located at the distal end of the aerosol-generating article.

EX35: An aerosol-generating article according to example EX34 wherein the first airflow pathway extends through the air-permeable plug of porous material.

EX36: An aerosol-generating article according to any one of examples EX1 to EX35 wherein the first aerosol-generating substrate comprises nicotine.

EX37: An aerosol-generating article according to any one of examples EX1 to EX36 wherein the second aerosol-generating substrate comprises nicotine.

EX38: An aerosol-generating article according to any one of examples EX1 to EX37 wherein the first aerosol-generating substrate comprises tobacco material.

EX39: An aerosol-generating article according to any one of examples EX1 to EX38 wherein the second aerosol-generating substrate comprises tobacco material.

EX40: An aerosol-generating article according to any one of examples EX1 to EX39 wherein the first aerosol-generating substrate comprises homogenised tobacco material.

EX41: An aerosol-generating article according to any one of examples EX1 to EX40 wherein the second aerosol-generating substrate comprises homogenised tobacco material.

EX42: An aerosol-generating article according to any one of examples EX1 to EX41 wherein the first aerosol-generating substrate comprises one or more aerosol formers.

EX43: An aerosol-generating article according to any one of examples EX1 to EX42 wherein the second aerosol-generating substrate comprises one or more aerosol formers.

EX44: An aerosol-generating article according to any one of examples EX1 to EX43 wherein the first aerosol-generating substrate comprises one or more flavourants.

EX45: An aerosol-generating article according to any one of examples EX1 to EX44 wherein the second aerosol-generating substrate comprises one or more flavourants.

EX46: An aerosol-generating article according to any one of examples EX1 to 45 wherein the composition of the first aerosol-generating substrate is the same as the composition of the second aerosol-generating substrate.

EX47: An aerosol-generating article according to any one of examples EX1 to 45 wherein the composition of the first aerosol-generating substrate is different to the composition of the second aerosol-generating substrate.

EX48: An aerosol-generating system comprising: an aerosol-generating article according to any one of examples EX1 to EX47; and an aerosol-generating device configured to heat the first aerosol-generating substrate and the second aerosol-generating substrate of the aerosol-generating article.

EX49: An aerosol-generating system according to example EX48 wherein the aerosol-generating device is configured to heat the first aerosol-generating substrate and the second aerosol-generating substrate of the aerosol-generating article simultaneously.

EX50: An aerosol-generating system according to example EX48 or EX49 wherein the aerosol-generating device is configured to heat the first aerosol-generating substrate and the second aerosol-generating substrate of the aerosol-generating article sequentially.

EX51: An aerosol-generating system according to any one of examples EX48 to EX50 wherein the aerosol-generating device is configured to heat the first aerosol-generating substrate and the second aerosol-generating substrate of the aerosol-generating article to the same temperature.

EX52: An aerosol-generating system according to any one of examples EX48 to EX51 wherein the aerosol-generating device is configured to heat the first aerosol-generating substrate and the second aerosol-generating substrate of the aerosol-generating article to different temperatures.

The invention will be further described, by way of example only, with reference to the accompanying drawings in which:

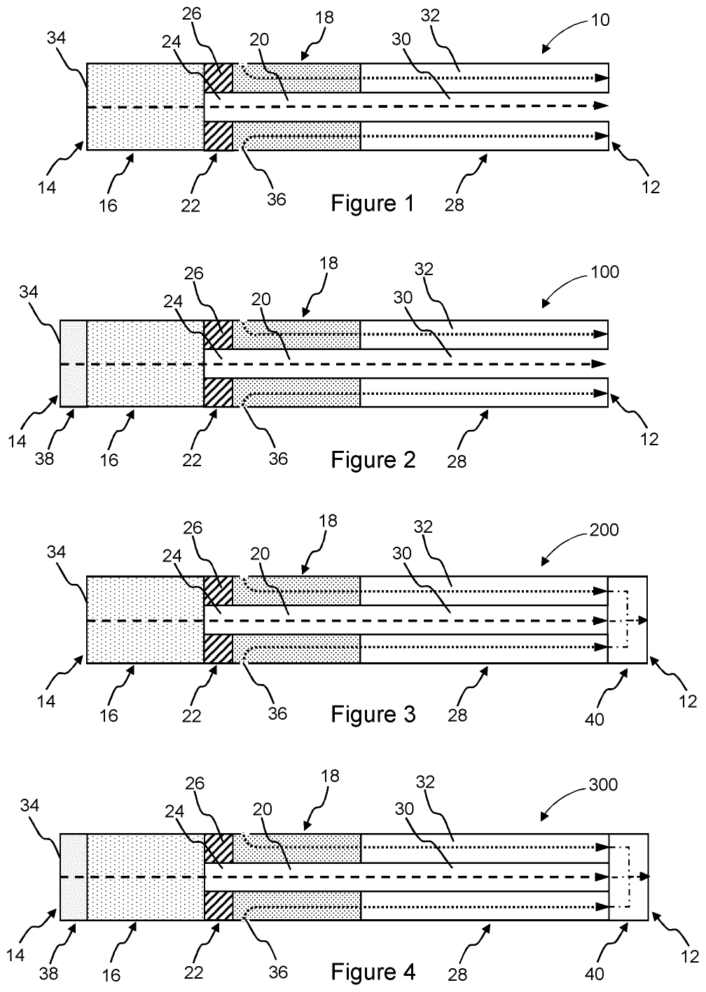

FIG. 1 shows a schematic longitudinal cross-section of a first embodiment of an aerosol-generating article according to the first aspect of the invention;

FIG. 2 shows a schematic longitudinal cross-section of a second embodiment of an aerosol-generating article according to the first aspect of the invention;

FIG. 3 shows a schematic longitudinal cross-section of a third embodiment of an aerosol-generating article according to the first aspect of the invention;

FIG. 4 shows a schematic longitudinal cross-section of a fourth embodiment of an aerosol-generating article according to the first aspect of the invention;

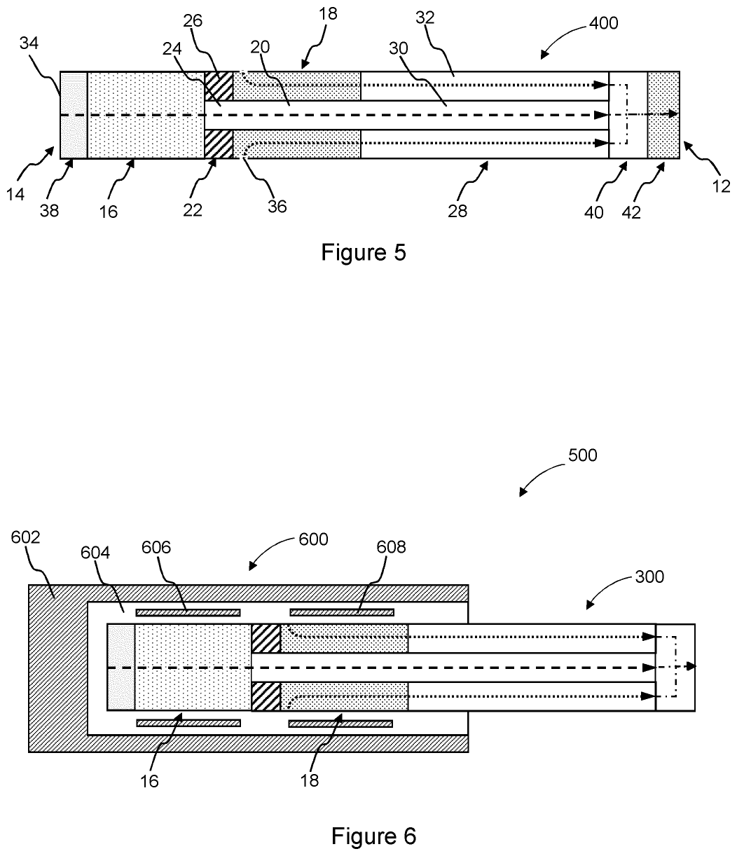

FIG. 5 shows a schematic longitudinal cross-section of a fifth embodiment of an aerosol-generating article according to the first aspect of the invention; and

FIG. 6 shows a schematic longitudinal cross-section of an embodiment of an aerosol-generating system according to the second aspect of the invention.

The first embodiment of an aerosol-generating article 10 according to the first aspect of the invention shown in FIG. 1 is substantially cylindrical and has a proximal end 12 and a distal end 14. The aerosol-generating article 10 comprises a first aerosol-generating substrate 16 located between the distal end 14 and the proximal end 12 of the aerosol-generating article 10 and a second aerosol-generating segment 18 located between the first aerosol-generating substrate 16 and the proximal end 12 of the aerosol-generating article 10.

The first aerosol-generating substrate 16 comprises a plug of aerosol-forming material circumscribed by a wrapper.

The second aerosol-generating substrate 18 comprises a plug of aerosol-forming material circumscribed by a wrapper. As shown in FIG. 1, an axial airflow channel 20 is provided in the second aerosol-generating substrate 18. The aerosol-forming material of the second aerosol-generating substrate 18 circumscribes the axial airflow channel 20. The axial airflow channel 20 and the aerosol-forming material of the second aerosol-generating substrate 18 are separated by an air-impermeable interface.

The aerosol-generating article 10 further comprises a first hollow tubular element 22 located between the first aerosol-generating substrate 16 and the second aerosol-generating segment 18. The first hollow tubular element 22 comprises an axial airflow channel 24 circumscribed by an air-impermeable wall 26.

The aerosol-generating article 10 also further comprises a second hollow tubular element 28 located between the second aerosol-generating segment 18 and the proximal end 12 of the aerosol-generating article 10. The second hollow tubular element 28 comprises an inner axial airflow channel 30 circumscribed by an outer air flow channel 32. The inner axial airflow channel 30 and the outer air flow channel 32 of the second hollow tubular element 28 are separated by an air-impermeable interface.

The first aerosol-generating substrate 16, first hollow tubular element 22, second aerosol-generating substrate 18, and second hollow tubular element 28 are arranged in abutting coaxial alignment and are circumscribed by an outer wrapper of sheet material such as, for example, cigarette paper, metallised paper, metal foil, or a metal foil-paper laminate.

The aerosol-generating article 10 comprises a first air inlet 34 at the distal end of the first aerosol-generating substrate 16. The first air inlet 34 is configured to admit air directly into the first aerosol-generating substrate 16 in an axial direction.

The aerosol-generating article 10 comprises a second air inlet 36 located about a periphery of the second aerosol-generating substrate 18. The second air inlet 36 comprises a circumferential row of perforations in the outer wrapper. The second air inlet 36 is configured to admit air directly into the second aerosol-generating substrate 18 in a radial direction.

As shown in FIG. 1, the axial airflow channel 24 of the first hollow tubular element 22, axial airflow channel 20 provided in the second aerosol-generating substrate 18, and inner axial airflow channel 30 of the second hollow tubular element 28 are coaxially aligned.

A first airflow pathway (shown by the dashed arrow in FIG. 1) extends from the first air inlet 34 through the first aerosol-generating substrate 16, the axial airflow channel 24 of the first hollow tubular element 22, the axial airflow channel 20 provided in the second aerosol-generating substrate 18, and the inner axial airflow channel 30 of the second hollow tubular element 28 to the proximal 12 end of the aerosol-generating article 10.

A second airflow pathway (shown by the dotted arrow in FIG. 1) extends from the second air inlet 36 through the second aerosol-generating substrate 18 and the outer airflow channel 32 of the second hollow tubular element 28 to the proximal 12 end of the aerosol-generating article 10.

The first airflow pathway and the second airflow pathway are isolated from one another. In use, the air-impermeable wall 26 of the first hollow tubular element 22, the air-impermeable interface between the axial airflow channel 20 provided in the second aerosol-generating substrate 18 and the aerosol-forming material of the second aerosol-generating substrate 18, and the air-impermeable interface between the inner axial airflow channel 30 and the outer air flow channel 32 of the second hollow tubular element 28 prevent air being drawn along the first airflow pathway from mixing with air being drawn along the second airflow pathway and vice versa.

In use, a first inhalable aerosol comprising volatile compounds released from the first aerosol-generating substrate 16 upon heating of the first aerosol-generating substrate 16 and entrained in air drawn along the first airflow pathway may exit the aerosol-generating article 10 through the proximal end 12 of the aerosol-generating article 12 for delivery to a user and a second inhalable aerosol comprising volatile compounds released from the second aerosol-generating substrate 18 upon heating of the second aerosol-generating substrate 18 and entrained in air drawn along the second airflow pathway may exit the aerosol-generating article through the proximal end 12 of the aerosol-generating article 10 for delivery to a user. The first inhalable aerosol and the second inhalable aerosol may mix inside the mouth of a user during inhalation by a user.

The second embodiment of an aerosol-generating article 100 according to the first aspect of the invention shown in FIG. 2 is of similar construction to the first embodiment of an aerosol-generating article 10 according to the first aspect of the invention shown in FIG. 1. The same reference numerals are used in FIG. 2 for parts of the aerosol-generating article 100 shown in FIG. 2 corresponding to parts of the aerosol-generating article 10 shown in FIG. 1.

The first aerosol-generating substrate 16 of the aerosol-generating article 10 shown in FIG. 1 is located at the distal end 14 of the aerosol-generating article 10. As shown in FIG. 2, the aerosol-generating article 100 shown in FIG. 2 differs from the aerosol-generating article 10 shown in FIG. 1 in that the aerosol-generating article 100 shown in FIG. 2 comprises a component 38 located between the first aerosol-generating substrate 16 and the distal end 14 of the aerosol-generating article 100.

The component 38 is located at the distal end 14 of the aerosol-generating article 10 and comprises an air-permeable plug of porous material such as, for example, cellulose acetate.

The aerosol-generating article 100 shown in FIG. 2 comprises a first air inlet 34 at the distal end of the component 38. The first air inlet 34 is configured to admit air directly into the component 38 in an axial direction.

In the aerosol-generating article 100 shown in FIG. 2 the first airflow pathway (shown by the dashed arrow in FIG. 2) extends from the first air inlet 34 through the component 38, the first aerosol-generating substrate 16, the axial airflow channel 24 of the first hollow tubular element 22, the axial airflow channel 20 provided in the second aerosol-generating substrate 18, and the inner axial airflow channel 30 of the second hollow tubular element 28 to the proximal 12 end of the aerosol-generating article 10.

The third embodiment of an aerosol-generating article 200 according to the first aspect of the invention shown in FIG. 3 is of similar construction to the first embodiment of an aerosol-generating article 10 according to the first aspect of the invention shown in FIG. 1. The same reference numerals are used in FIG. 3 for parts of the aerosol-generating article 200 shown in FIG. 3 corresponding to parts of the aerosol-generating article 10 shown in FIG. 1.

The second hollow tubular element 28 of the aerosol-generating article 10 shown in FIG. 1 is located at the proximal end 12 of the aerosol-generating article 10. As shown in FIG. 3, the aerosol-generating article 200 shown in FIG. 3 differs from the aerosol-generating article 10 shown in FIG. 1 in that the aerosol-generating article 200 shown in FIG. 3 comprises a mixing chamber 40 located between the second hollow tubular element 28 of the aerosol-generating article 200 and the proximal end 12 of the aerosol-generating article 200.

In the aerosol-generating article 200 shown in FIG. 3 the first airflow pathway (shown by the dashed arrow in FIG. 3) extends from the first air inlet 34 through the first aerosol-generating substrate 16, the axial airflow channel 24 of the first hollow tubular element 22, the axial airflow channel 20 provided in the second aerosol-generating substrate 18, and the inner axial airflow channel 30 of the second hollow tubular element 28 to the mixing chamber 40. In the aerosol-generating article 200 shown in FIG. 3 the second airflow pathway (shown by the dotted arrow in FIG. 1) extends from the second air inlet 36 through the second aerosol-generating substrate 18 and the outer airflow channel 32 of the second hollow tubular element 28 to the mixing chamber 40.

A third airflow pathway (shown by the dashed and dotted arrow in FIG. 3) extends from the first airflow pathway and the second airflow pathway through the mixing chamber 40 to the proximal end 12 of the aerosol-generating article 300.

In use, a first inhalable aerosol comprising volatile compounds released from the first aerosol-generating substrate 16 upon heating of the first aerosol-generating substrate 16 and entrained in air drawn along the first airflow pathway may be drawn into the mixing chamber 40 and a second inhalable aerosol comprising volatile compounds released from the second aerosol-generating substrate 18 upon heating of the second aerosol-generating substrate 18 and entrained in air drawn along the second airflow pathway may be drawn into the mixing chamber 40. The first inhalable aerosol and the second inhalable aerosol may mix inside the mixing chamber 40 to form a combined inhalable aerosol that may exit the aerosol-generating article 300 through the proximal end 12 of the aerosol-generating article 300 for delivery to a user.

The fourth embodiment of an aerosol-generating article 300 according to the first aspect of the invention shown in FIG. 4 is of similar construction to the third embodiment of an aerosol-generating article 200 according to the first aspect of the invention shown in FIG. 3. The same reference numerals are used in FIG. 4 for parts of the aerosol-generating article 300 shown in FIG. 4 corresponding to parts of the aerosol-generating article 200 shown in FIG. 3.

In the aerosol-generating article 200 shown in FIG. 3 the first aerosol-generating substrate 16 of the aerosol-generating article 200 is located at the distal end 14 of the aerosol-generating article 200. As shown in FIG. 4, the aerosol-generating article 300 shown in FIG. 4 differs from the aerosol-generating article 200 shown in FIG. 3 in that the aerosol-generating article 300 shown in FIG. 4 comprises a component 38 located between the first aerosol-generating substrate 16 and the distal end 14 of the aerosol-generating article 300.

The component 38 is located at the distal end 14 of the aerosol-generating article 300 and comprises an air-permeable plug of porous material such as, for example, cellulose acetate.

The aerosol-generating article 300 shown in FIG. 4 comprises a first air inlet 34 at the distal end of the component 38. The first air inlet 34 is configured to admit air directly into the component 38 in an axial direction.

In the aerosol-generating article 300 shown in FIG. 4 the first airflow pathway (shown by the dashed arrow in FIG. 4) extends from the first air inlet 34 through the component 38, the first aerosol-generating substrate 16, the axial airflow channel 24 of the first hollow tubular element 22, the axial airflow channel 20 provided in the second aerosol-generating substrate 18, and the inner axial airflow channel 30 of the second hollow tubular element 28 to the mixing chamber 40 of the aerosol-generating article 10.

The fifth embodiment of an aerosol-generating article 400 according to the first aspect of the invention shown in FIG. 5 is of similar construction to the fourth embodiment of an aerosol-generating article 300 according to the first aspect of the invention shown in FIG. 4. The same reference numerals are used in FIG. 5 for parts of the aerosol-generating article 400 shown in FIG. 5 corresponding to parts of the aerosol-generating article 300 shown in FIG. 4.

In the aerosol-generating article 300 shown in FIG. 4 the mixing chamber 40 of the aerosol-generating article 300 is located at the proximal end 12 of the aerosol-generating article 300. As shown in FIG. 5, the aerosol-generating article 400 shown in FIG. 5 differs from the aerosol-generating article 300 shown in FIG. 4 in that the aerosol-generating article 400 shown in FIG. 5 comprises a mouthpiece 42 located between the mixing chamber 40 and the proximal end 12 of the aerosol-generating article 400.

The mouthpiece 42 is located at the proximal end 12 of the aerosol-generating article 400 and comprises an air-permeable plug of porous material such as, for example, cellulose acetate.

In the aerosol-generating article 400 shown in FIG. 5 the third airflow pathway (shown by the dashed and dotted arrow in FIG. 5) extends from the first airflow pathway and the second airflow pathway through the mixing chamber 40 and the mouthpiece 42 to the proximal end 12 of the aerosol-generating article 400.

The embodiment of an aerosol-generating system 500 according to the second aspect of the invention shown in FIG. 6 comprises an aerosol-generating article 300 according to the first aspect of the invention as shown in FIG. 4 and an electrically operated handheld aerosol-generating device 600.

The aerosol-generating device 600 comprises a housing 602 defining a device cavity 604 configured to receive a distal portion of the aerosol-generating article 300.

The aerosol-generating device 600 comprises a first hollow tubular susceptor sleeve 606 and a second hollow tubular susceptor sleeve 608. The first hollow tubular susceptor sleeve 606 is configured to heat the first aerosol-generating substrate 16 of the aerosol-generating article 300 by conduction when the distal portion of the aerosol-generating article 300 is received in the device cavity 604. The second hollow tubular susceptor sleeve 608 is configured to heat the second aerosol-generating substrate 18 of the aerosol-generating article 300 by conduction when the distal portion aerosol-generating article 300 is received in the device cavity 604.

The aerosol-generating device 600 further comprises an inductor comprising a first induction coil (not shown) and a second induction coil (not shown), a power supply in the form of a battery (not shown), such as a rechargeable lithium ion battery, and control circuitry (not shown). The control circuitry controls the supply of electrical power from the battery to the first induction coil and the second induction coil of the inductor.

In use, a fluctuating or alternating electromagnetic field produced by the first induction coil of the inductor induces eddy currents in the first hollow tubular susceptor sleeve 606, causing the first hollow tubular susceptor 606 to heat up. Heat generated in the first hollow tubular susceptor sleeve 606 is transferred to the first aerosol-generating substrate 16 of the aerosol-generating article 300 by conduction.

In use, a fluctuating or alternating electromagnetic field produced by the second induction coil of the inductor induces eddy currents in the second hollow tubular susceptor sleeve 608, causing the second hollow tubular susceptor 608 to heat up. Heat generated in the second hollow tubular susceptor sleeve 606 is transferred to the second aerosol-generating substrate 18 of the aerosol-generating article 300 by conduction.

The inductor of the aerosol-generating device 600 may be configured to heat the first hollow tubular susceptor sleeve 606 and the second hollow tubular susceptor sleeve 608 to the same temperature or to different temperatures. The aerosol-generating device 600 may thereby be configured to heat the first aerosol-generating substrate 16 and the second aerosol-generating substrate 18 of the aerosol-generating article 300 simultaneously or sequentially to the same temperature or to different temperatures.

The inductor of the aerosol-generating device 600 may be configured to heat the first hollow tubular susceptor sleeve 606 and the second hollow tubular susceptor sleeve 608 simultaneously or sequentially. The aerosol-generating device 600 may thereby be configured to heat the first aerosol-generating substrate 16 and the second aerosol-generating substrate 18 of the aerosol-generating article 300 simultaneously or sequentially.

It will be appreciated that aerosol-generating articles according to the first aspect of the invention may also be suitable for use with other types of aerosol-generating devices.

For example, it will be appreciated that aerosol-generating articles according to the first aspect of the invention may comprise a first susceptor in thermal contact with the first aerosol-generating substrate and a second susceptor in thermal contact with the second aerosol-generating substrate. Aerosol-generating articles according to the first aspect of the invention may be used with an aerosol-generating device comprising an inductor configured to heat the first susceptor and the second susceptor of the aerosol-generating article.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies.

1.-16. (canceled)

17. An aerosol-generating article for generating an inhalable aerosol upon heating, the aerosol-generating article having a proximal end and a distal end and comprising:
a first aerosol-generating substrate located between the distal end and the proximal end of the aerosol-generating article;
a first air inlet configured to admit air into the aerosol-generating article;
a second aerosol-generating substrate located between the first aerosol-generating substrate and the proximal end of the aerosol-generating article;
a second air inlet configured to admit air into the aerosol-generating article;
a first airflow pathway extending from the first air inlet through the first aerosol-generating substrate towards the proximal end of the aerosol-generating article; and
a second airflow pathway extending from the second air inlet through the second aerosol-generating substrate towards the proximal end of the aerosol-generating article,
wherein the first airflow pathway and the second airflow pathway are isolated from one another.

18. The aerosol-generating article according to claim 17, wherein the first air inlet is further configured to admit air into the aerosol-generating article in an axial direction.

19. The aerosol-generating article according to claim 17, wherein the second air inlet is further configured to admit air into the aerosol-generating article in a radial direction.

20. The aerosol-generating article according to claim 19, wherein an axial airflow channel is provided in the second aerosol-generating substrate.

21. The aerosol-generating article according to claim 20, wherein the first airflow pathway extends through the axial airflow channel provided in the second aerosol-generating substrate.

22. The aerosol-generating article according to claim 20,
further comprising a first hollow tubular element located between the first aerosol-generating substrate and the second aerosol-generating substrate,
wherein the first hollow tubular element comprises an axial airflow channel and an air-impermeable wall.

23. The aerosol-generating article according to claim 22, wherein the first airflow pathway extends through the axial airflow channel of the first hollow tubular element.

24. The aerosol-generating article according to claim 17,
further comprising a second hollow tubular element located between the second aerosol-generating substrate and the proximal end of the aerosol-generating article,
wherein the second hollow tubular element comprises an inner axial airflow channel and an outer axial airflow channel.

25. The aerosol-generating article according to claim 24, wherein the first airflow pathway extends through the inner axial channel of the second hollow tubular element and the second airflow pathway extends through the outer axial airflow channel of the second hollow tubular element.

26. The aerosol-generating article according to claim 17,
further comprising a mixing chamber located between the second aerosol-generating substrate and the proximal end of the aerosol-generating article,
wherein the first airflow pathway extends from the first air inlet through the first aerosol-generating substrate to the mixing chamber and the second airflow pathway extends from the second air inlet through the second aerosol-generating substrate to the mixing chamber.

27. The aerosol-generating article according to claim 26, wherein the mixing chamber is located at the proximal end of the aerosol-generating article.

28. The aerosol-generating article according to claim 17, further comprising an air-permeable plug of porous material located at the distal end of the aerosol-generating article.

29. The aerosol-generating article according to claim 17, wherein a composition of the first aerosol-generating substrate is different from a composition of the second aerosol-generating substrate.

30. The aerosol-generating article according to claim 17, wherein one or both of the first aerosol-generating substrate and the second aerosol-generating substrate comprises tobacco material.

31. An aerosol-generating system, comprising:
an aerosol-generating article according to claim 17; and
an aerosol-generating device configured to heat the first aerosol-generating substrate and the second aerosol-generating substrate of the aerosol-generating article.

32. The aerosol-generating system according to claim 31, wherein one or both of the aerosol-generating article and the aerosol-generating device comprises one or more susceptors.
